(19) United States
(12) Patent Application Publication
(10) Pub. No.: US 2010/0143528 A1
(43) Pub. Date: Jun. 10, 2010

(54) Dough-Spreading Apparatus for the Preparation of Pizzas

(76) Inventor: Stefano Tomatis, PEVERAGNO (IT)

Correspondence Address: Modiano & Associati, Via Meravigli 16, Milan, 20123, IT

(21) Appl. No.: 11/992,397

(22) PCT Filed: Mar. 2, 2007
(86) PCT No.: PCT/IT2007/000156

§ 371 Date: Mar. 21, 2008

(51) Int. Cl. A21C 11/06

(52) U.S. Cl. 425/394

(57) ABSTRACT

Two disk-shaped pans are moulded with radial depressions each having a substantially V-shaped transverse profile, with a progressively increasing width and depth from the center of each pan to its border. Motor elements such as a four-bar linkage are arranged for rotating one of the pans around its axis with a reciprocating motion. The other pan can be pressed against the former to squeeze a lump of dough placed therebetween.

### BACKGROUND OF THE INVENTION

In the preparation of pizzas, dough-spreading apparatuses for semi-professional use and also for home use are known in which a lump of leavened dough placed on a tray is squeezed by a flat pan that is lowered vertically upon the dough by manual or motorized pressure means. The dough-lump is spread because the applied pressure causes the dough to run in the only unconstrained direction, i.e. in a radial direction.

A first drawback of this approach is that the dough is spread not only by plastic deformation, but also partly by elastic deformation, so that the squeezed pizza, after being released by the apparatus, tends to shrink back and swell again. Moreover, the strong pressure necessary for spreading the dough tends to expel the leavening gas scattered in the dough, thereby making the dough dense and noxiously affecting the quality of the pizza eventually resulting after cooking.

### SUMMARY OF THE INVENTION

The main object of the invention is to provide a dough-spreading apparatus for the preparation of pizzas, by which an unskilled operator can quickly obtain a thin pizza sheet from a lump of risen dough, while avoiding the above drawbacks. More particularly, the apparatus should not compact the dough excessively, and should break its grain in order to reduce its elastic return.

Another object is to provide an apparatus of low complexity and cost.

The above objects, as well as other objects and advantages, such as will appear from the following disclosure, are attained by the invention with a dough-spreading apparatus for the preparation of pizzas having the features set forth in claim 1, whereby the dependent claims recite other advantageous features of the invention.

### BRIEF DESCRIPTION OF THE DRAWINGS

The invention will be described in more detail, by way of a non-limiting example, with reference to the attached drawings, wherein:

FIG. 1 is a plan view of a preferred embodiment of the dough-spreading apparatus according to the invention;

FIG. 2 is a partially cross-sectioned side view of the dough-spreading apparatus of FIG. 1;

FIG. 3 is a enlarged, perspective view of a pan used in the apparatus of FIGS. 1 and 2.

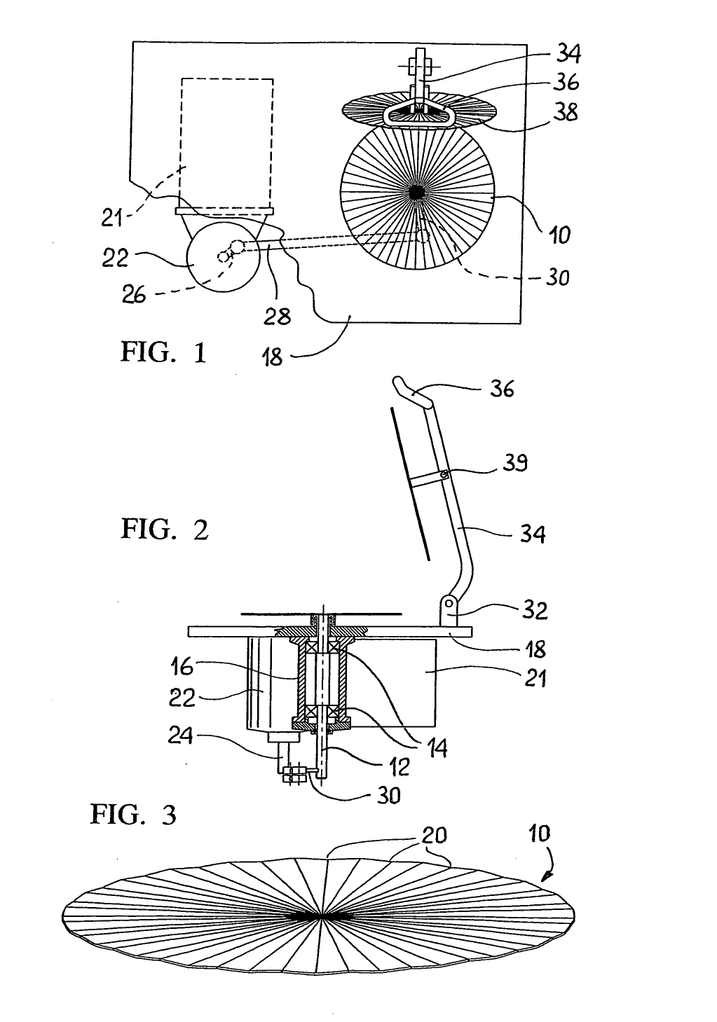

### DESCRIPTION OF THE PREFERRED EMBODIMENTS

With reference to the Figures, a disk-shaped flat pan 10, preferably of stainless steel sheet, is coaxially carried on a shaft 12, which is vertically and rotatably supported by bearings 14 in a sleeve 16 attached below a worktable 18.

With particular reference to FIG. 3, the surface of pan 10 has a coaxial starlike arrangement of identical radial depressions 20. The depressions are shallow and have a substantially V-shaped profile, and are open at the pan border. Accordingly, the transverse cross-section of each depression 20 progressively widens from the pan center to its peripheral border, and the depth of the depression increases similarly.

Preferably, pan 10 is cut from a stainless steel sheet of about 3 mm thickness, and is moulded under a press to form the depressions 20. The diameter of the pan is proportionate to the desired diameter of the pizza: a typical value is, for instance, 250 mm. The number of depressions is, preferably, a score, although it may vary considerably, e.g. in the range 12 to 30. The depth of each depression in axial direction and at the pan border is preferably about 2 mm, although it can also vary, typically from 1 to 4 mm, also depending on the diameter of the pan.

A motor 21 with reduction gear 22 is mounted under the worktable 18. The driving shaft of the reduction gear carries a short crank 26. A rod 28 connects crank 26 to a second crank 30 projecting from the lower end of shaft 12, which carries pan 10, thereby forming a four-bar linkage, whose geometry is such that when the output shaft 24 of reduction gear 22 turns, the end of crank 30 undergoes a reciprocating movement, whereby shaft 12 and consequently pan 10 execute a to-and-fro movement through a small angle, at a frequency determined by the turning speed of shaft 24 and reduction gear 22.

Four-bar linkage 26-28-30 is designed so that the angle of rotation of pan 10 around its axis is preferably about 15°, but, more generally, the range of movement of the pan might also be much narrower or wider, e.g. in the range 10° a 20°. The velocity ratio of reduction gear 22 with respect to motor 21 is such that the frequency of the reciprocating motion of pan 10 is in the range 100 to 200 oscillations, per minute.

A bracket 32 is mounted above worktable 18, and an arm 34, provided with a handle 36 at its free end, is pivoted on the bracket. Arm 34 supports a second pan 38, hinged at an intermediate point 39. Pan 38 is similar to pan 10, being shaped with identical depressions, so that an operator can manipulate handle 36 to lower arm 34 and press pan 38 coaxially onto pan 10.

In use, after the operator has floured pan 10, he places a lump of leavened dough in the center of it and, while motor 21 is in motion so that pan 10 oscillates, the operator then lowers pan 38 onto it by manipulating handle 34. The pressure exercized by pan 26 squeezes the dough, forcing it to flow in the directions not subjected to compression, i.e. in the radial directions. The flow of the dough is further helped by the rolling applied to the dough by the ridges between the depressions of both pans, which move reciprocally with respect to each other in a tangential direction. Such action breaks the grain of the dough, thereby weakening the internal ties among its fibers, and therefore helping the spreading of the dough and reducing the elastic return of the dough after spreading.

Numerous changes can be made to the preferred embodiment disclosed above.

Pans 10 and 38 might have different diameters. The profiles of depressions 20 could be different from a V-shape, e.g. they could be rounded or otherwise. The angular amplitude of depressions 20, rather than being uniform in each case, might be different among the several depressions: for instance, wider and narrower depressions might alternate, and the same holds for the depth of the depressions. The number of depressions in both pans might also be different.

The motion of pan 10 could of course be obtained by other kinds of mechanisms, and even rotary motor 21 with reduction gear could be replaced with a reciprocating actuator, not only electric, but also hydraulic or pneumatic, such as a cylinder. It should also be understood that, although the oscillating pan in the preferred embodiment is located in a fixed, lower position, the roles of both pans could be reversed.

What is claimed is:

1-12. (canceled)

13. A dough-spreading apparatus for the preparation of pizzas, comprising two pans that are pressable together to squeeze a lump of dough placed therebetween, wherein the facing surfaces of the pans have respective pluralities of radial depressions extending from the respective centers of the pans to their respective peripheral borders, and wherein motor means are arranged for rotating one of the pans around its axis with reciprocating motion through a predetermined angle and at a predetermined frequency.

14. The dough-spreading apparatus of claim 13, wherein each pan comprises 12 to 30 radial depressions.

15. The dough-spreading apparatus of claim 13, wherein each pan comprises about 20 radial depressions.

16. The dough-spreading apparatus of claim 13, wherein each of said radial depressions has a substantially V-shaped transverse profile, having a progressively increasing width and depth from the center of each pan to its border.

17. The dough-spreading apparatus of claim 16, wherein the depth of each radial depression, measured axially to the respective pan at the border of the pan is in the range 1 mm to 4 mm.

18. The dough-spreading apparatus of claim 13, wherein said depth is about 2 mm.

19. The dough-spreading apparatus of claim 13, wherein said predetermined angle of reciprocating rotation is in the range 10° to 20°.

20. The dough-spreading apparatus of claim 19, wherein said predetermined angle of reciprocating rotation is 15°.

21. The dough-spreading apparatus of claim 13, wherein said predetermined frequency of reciprocating rotation is in the range 100 to 200 oscillations per minute.

22. The dough-spreading apparatus of claim 13, wherein said alternating motor means comprise a rotating motor device driving the reciprocating rotation of one of said pans by means of a motion-converting crank mechanism.

23. The dough-spreading apparatus of claim 22, wherein said motion-converting crank mechanism is a four-bar linkage.

24. The dough-spreading apparatus of claim 22, wherein said rotating motor device is a unit comprising an electric motor and a reduction gear driven thereby.
